(19) United States
(12) Patent Application Publication
(10) Pub. No.: US 2010/0006066 A1
(43) Pub. Date: Jan. 14, 2010

(54) VARIABLE PRIMARY CURRENT FOR IONIZATION

(76) Inventors: Nicholas Danne, Belleville, MI (US); Guoming Zhu, Novi, MI (US); Mike Dale, Milan, MI (US)

Correspondence Address: FRASER CLEMENS MARTIN & MILLER LLC, 28366 KENSINGTON LANE, PERRYSBURG, OH, 43551, US

(21) Appl. No.: 12/172,698

(22) Filed: Jul. 14, 2008

(51) Int. Cl. F02P 3/045

(52) U.S. Cl. 123/406.26; 123/609; 701/102

(57) ABSTRACT

A system and a method for controlling an ignition coil charge duration are disclosed, wherein the system includes an ignition coil in electrical communication with a control unit and at least one of an ionization detection circuit and at least one sensor. The control unit controls the ignition coil charge duration to facilitate detection and militate against an undesirable interruption of an ionization output signal during the combustion process.

### FIELD OF THE INVENTION

The present invention relates to an ignition system for an internal combustion engine. More particularly, the invention is directed to a system and a method for controlling an ignition coil charge duration.

### BACKGROUND OF THE INVENTION

Internal combustion (IC) engines, commonly used in various automotive and non-automotive applications, are designed to maximize power subject to meeting exhaust emission requirements and minimizing fuel consumption. Presently, the combustion process of an IC engine can be controlled in a closed-loop using in-cylinder ion sensing. In-cylinder ion sensing provides feedback control and diagnostics including: MBT (Minimal advance for the Best Torque or Maximum Brake Torque Timing) detection, engine knock detection, rate and phasing of combustion, and misfire On-Board Diagnostics (OBD).

Presently, engine knock limits the maximization of engine power and fuel economy. Therefore, the ability to detect engine knock and operate the engine at the knock limit, below engine damage and NVH thresholds, is essential for power output and fuel economy. Typically, an engine control unit (ECU) routinely monitors an ionization current from each individual cylinder of the engine in order to determine combustion information. Depending on the ionization current, the ECU may make adjustments to maximize power, minimize fuel consumption, and avoid undesirable engine operational conditions, such as engine knock and misfire.

In a conventional spark ignited IC engine, the combustion is initiated by discharging an ignition coil, which causes a spark at the corresponding spark plug. The duration of the ignition coil charge is known as dwell. Increasing the dwell improves the engine combustion stability due to increased spark energy and voltage. However, increasing the electrical spark energy leads to an increase in spark duration. During in-cylinder ion sensing, measurement of the ionization current commences subsequent the completion of the spark, independent of a crank angle of the engine. However, combustion information is only produced over certain degrees of crank angle of the engine (crank angle window). Therefore, where the duration of the spark encroaches upon the crank angle window, the ECU is prevented from receiving a proper ionization output signal. Illustrative of this problem is the spark occurring at high engine speeds, such as 6000 rpm. At such engine speeds, a spark duration of one millisecond can cover approximately thirty-six (36) degrees of crank rotation of the engine. Accordingly, the ionization current cannot be detected during that period, resulting in an interruption of combustion information provided to the ECU such as MBT data, for example. Without the combustion information, the ECU cannot make the necessary adjustments to operate the engine at its MBT timing or avoid engine knock and misfire. Therefore, there is a need for a system and a method that controls the dwell of the ignition coil to allow measurement of the ionization current at high engine speeds while maintaining engine combustion stability.

Presently, prior art ignition systems disable in-cylinder ion sensing at high engine speeds or reduce the duration of the spark by utilizing an ignition coil with a significantly higher firing current than the industry standard or adding a secondary impedance to the ignition coil. However, the prior art systems increase cost and increase ignition coil heat dissipation, as well as degrade the ionization output signal.

It would be desirable to develop a system and a method for controlling the dwell of the ignition coil, which efficiently and cost effectively militate against an interruption of combustion information provided to the electronic control unit.

### SUMMARY OF THE INVENTION

In concordance and agreement with the present invention, a system and a method for controlling the dwell of the ignition coil, which efficiently and cost effectively militate against an interruption of combustion information provided to the electronic control unit, have surprisingly been discovered.

In one embodiment, the ignition system for controlling ignition coil charge duration comprises: at least one sensor adapted to generate and transmit a signal which represents an operating condition of the ignition system; and a control unit in electrical communication with the at least one sensor, the control unit adapted to receive and analyze the signal, and generate a dwell duration command signal in response to the analysis of the signal, wherein the dwell duration command signal controls a primary current of at least one ignition coil to facilitate detection of an ionization output signal.

In another embodiment, the ignition system for controlling an ignition coil charge duration comprises: at least one ignition coil integrated with an ionization detection circuit, the ionization detection circuit adapted to generate and transmit an ionization output signal; and a control unit in electrical communication with the ionization detection circuit, the control unit including: a calculation module adapted to receive and analyze the ionization output signal, and generate and transmit a spark duration feedback signal in response to the analysis of the ionization output signal; a control module in electrical communication with the calculation module, the control module adapted to receive and analyze the spark duration feedback signal, and generate and transmit an error spark timing signal in response to the analysis of the spark duration feedback signal; and a controller in electrical communication with the control module, the controller adapted to receive and analyze the error spark timing signal, and generate and transmit a dwell duration command signal in response to the analysis of the error spark timing signal, wherein the dwell duration command signal controls a primary current of the at least one ignition coil to facilitate detection of the ionization output signal.

The invention also provides methods for controlling the dwell duration of an ignition coil.

One method comprises the steps of: providing at least one sensor adapted to generate and transmit a signal which represents an operating condition of an ignition system; providing a control unit in electrical communication with the at least one sensor, the control unit adapted to receive and analyze the signal, and generate a dwell duration command signal in response to the analysis of the signal, wherein the dwell duration command signal represents a desired dwell duration and controls a primary current of at least one ignition coil to facilitate detection of an ionization output signal; generating the signal from the operating condition of the ignition system; transmitting the signal to the control unit; analyzing the signal; generating the dwell duration command signal in response to the analysis of the signal; and transmitting the dwell duration command signal to the ignition system.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of an open-loop system for controlling an ignition coil dwell of an internal combustion engine according to an embodiment of the present invention;

FIG. 2 is a schematic block diagram of a closed-loop system for controlling an ignition coil dwell of an internal combustion engine according to an embodiment of the present invention;

FIG. 3 is a schematic block diagram of a closed-loop system for controlling an ignition coil dwell of an internal combustion engine according to another embodiment of the present invention;

FIG. 4 is a graph of a typical primary current of an ignition coil at high engine speeds versus time;

FIG. 5 is a graph of a typical secondary voltage of the ignition coil at high engine speeds versus time;

FIG. 6 is a graph of a typical ionization current and an ionization output signal of the ignition coil at high engine speeds versus crank angle;

FIG. 7 is a graph that illustrates the effect of decreasing the primary current of the ignition coil at high engine speeds on dwell;

FIG. 8 is a graph that illustrates the effect of decreasing the primary current of the ignition coil at high engine speeds on a secondary voltage thereof;

FIG. 9 is a graph that illustrates the effect of decreasing the primary current of the ignition coil at high engine speeds on the ionization current and the ionization output signal;

FIG. 10 is a graph that illustrates the effect of delaying the primary current of the ignition coil at high engine speeds on dwell;

FIG. 11 is a graph that illustrates the effect of delaying the primary current of the ignition coil at high engine speeds on the secondary voltage thereof; and

FIG. 12 is a graph that illustrates the effect of delaying the primary current of the ignition coil at high engine speeds on the ionization current and the ionization output signal.

### DETAILED DESCRIPTION OF THE INVENTION

The following detailed description and appended drawings describe and illustrate an exemplary embodiment of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

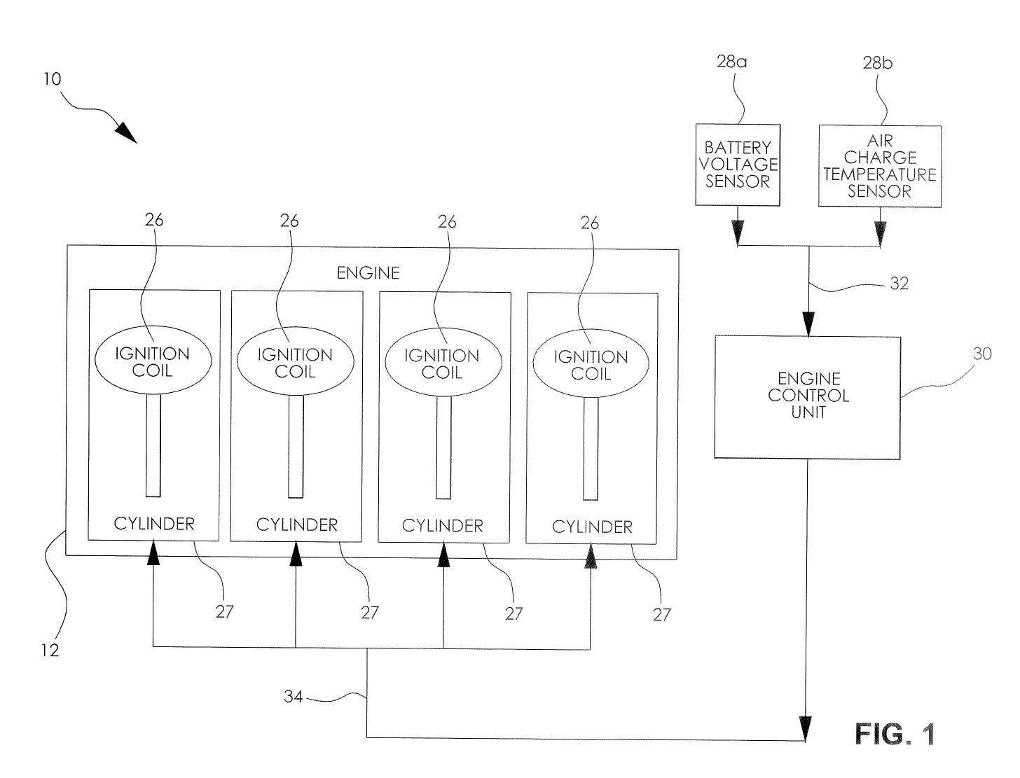

FIG. 1 shows an open-loop system 10 for controlling an ignition coil dwell according to an embodiment of the present invention. The system 10 as described herein may be used in an internal combustion engine 12 of any number of cylinders such as a four, six, or eight cylinder engine, for example. The system 10 includes at least one ignition coil 26, at least one sensor 28a, 28b, and an engine control unit (ECU) 30. It is understood that the at least one sensor 28a, 28b can be any sensor as desired such as an engine load sensor, an engine temperature sensor, an engine position sensor, a battery voltage sensor, and an air charge temperature sensor, for example. It is further understood that additional or fewer sensors, modules, and components may be included in the system 10, as desired.

Each ignition coil 26 is disposed in a respective cylinder 27 of the engine 12. The ignition coil 26 is connected to a switch and includes a primary winding inductively coupled to a secondary winding. The ECU 30 controls the switch such that the primary winding is in electrical communication with a power supply (battery) when the switch is closed and disconnected from the power supply when the switch is open. The power supply provides an electrical current, commonly referred to as a primary current (Iₚ), to the primary winding to charge the ignition coil 26. The charge duration of the ignition coil 26 is known in the art as dwell. The secondary winding is coupled to a spark plug. At the end of dwell (at the moment the switch is turned off), the energy stored at the secondary winding of the ignition coil 26 is discharged through the spark plug, causing a spark. A duration of the spark is directly proportional to the dwell duration of the ignition coil 26.

In the embodiment shown, a battery voltage sensor 28a and an air charge temperature sensor 28b are in electrical communication with the ECU 30. The sensors 28a, 28b are adapted to generate and transmit a signal 32 which represents a battery voltage and an air charge temperature, respectively, to the ECU 30. The ECU 30 is adapted to receive and analyze the signals 32 from the sensors 28a, 28b to determine a desired dwell duration based upon at least one of the battery voltage and the air charge temperature. As a non-limiting example, the desired dwell duration may be determined using a lookup table. The ECU 30 is further adapted to generate and transmit a dwell duration command signal 34 to each cylinder 27. The dwell duration command signal 34 represents the desired dwell duration from the lookup table.

In use, the battery voltage sensor 28a and the air charge temperature sensor 28b generate and transmit respective signals 32 to the ECU 30. The ECU 30 receives and analyzes the signals 32 from the sensors 28a, 28b to determine the desired dwell duration using the lookup table. The ECU 30 generates and transmits the dwell duration command signal 34 based on the desired dwell duration to each cylinder 27. The dwell duration command signal 34 controls the primary current of each ignition coil 26 by opening and closing the switch connected to the ignition coil 26, and thereby controls the actual dwell duration thereof.

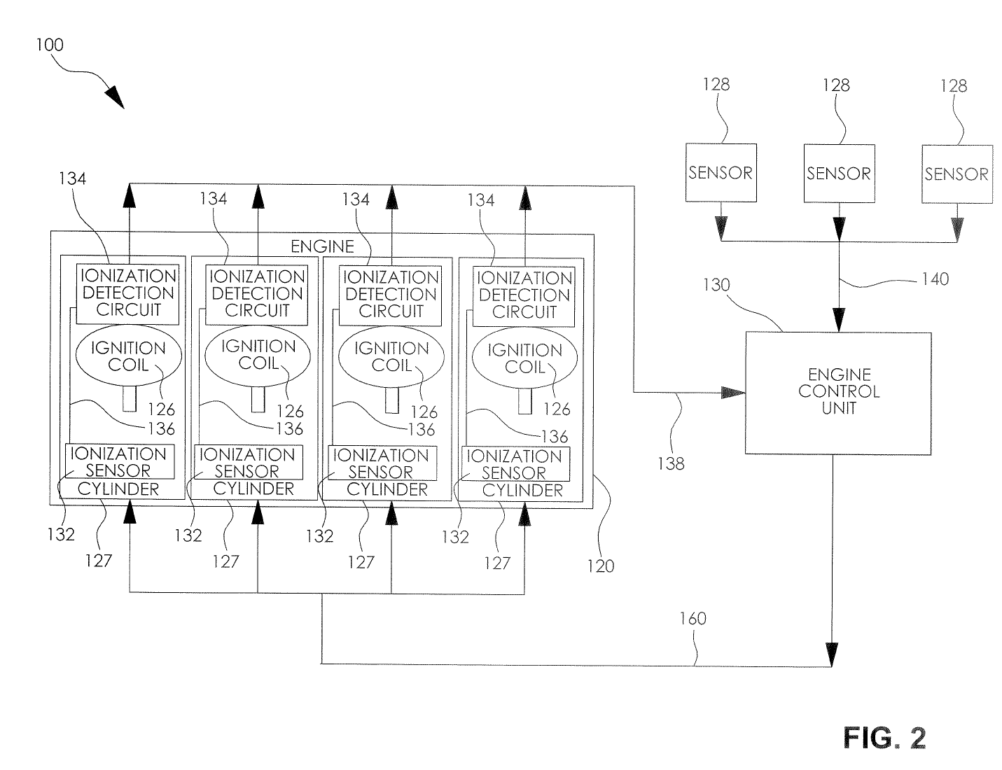

FIG. 2 shows a closed-loop system 100 for controlling an ignition coil dwell according to an embodiment of the present invention. The system 100 as described herein may be used in an internal combustion engine 120 of any number of cylinders such as a four, six, or eight cylinder engine, for example. The system 100 includes at least one ignition coil 126, at least one sensor 128, and an engine control unit (ECU) 130. It is understood that the at least one sensor 128 can be any sensor as desired such as an engine load sensor, an engine temperature sensor, an engine position sensor, a battery voltage sensor, and an air charge temperature sensor, for example. It is further understood that additional or fewer sensors, modules, and components may be included in the system 100, as desired.

Each ignition coil 126 is disposed in a respective cylinder 127 of the engine 120. The ignition coil 126 is connected to a switch and includes a primary winding inductively coupled to a secondary winding. The ECU 130 controls the switch such that the primary winding is in electrical communication with a power supply (battery) when the switch is closed and disconnected from the power supply when the switch is open. The power supply provides an electrical current, commonly referred to as a primary current (Iₚ), to the primary winding. The secondary winding is coupled to a spark plug. In a spark ignition engine, the spark plug extends inside of the engine combustion chamber and may be used as an ionization sensor 132. Use of the spark plug as the ionization sensor 132 eliminates the need to place a separate sensor into the combustion chamber to monitor conditions inside of the combustion chamber. It is understood, however, that other ionization sensors can be used if desired.

The spark plug includes a ground electrode and a spaced apart center electrode, forming a gap therebetween. An ionization detection circuit 134 integrated with each of the ignition coil 126 is adapted to apply a bias voltage across the gap of the spark plug. The bias voltage attracts free ions produced during the combustion process of the engine to the gap, creating an ionization current 136. The ionizatior detection circuit 134 is further adapted to measure and condition the ionization current 136 to generate an ionization output signal 138 and transmit the ionization output signal 138 to the ECU 130. It is understood that the ionization detection circuit 134 can measure and condition the ionization current 136 by at least one of a filtering, amplifying, and a transforming of the ionization current 136, for example. The ionization output signal 138 represents a measure of a local combustion mixture conductivity in the cylinder 127 during the combustion process. The local combustion mixture conductivity is influenced not only by the complex chemical reactions that occur during combustion, but also by the local temperature and turbulence flow during the combustion process.

As illustrated, the at least one sensor 128 is in electrical communication with the ECU 130. The at least one sensor 128 is adapted to generate and transmit a signal 140 which represents an operating condition of the engine 120 such as an engine speed, an engine load, and air charge temperature, for example, to the ECU 130. In the embodiment shown, the ECU 130 is adapted to receive and analyze the signal 140 from the at least one sensor 128 to generate a desired dwell duration. The ECU 130 is also in electrical communication with the ionization detection circuit 134 and adapted to receive the ionization output signal 138. The ionization output signal 138 typically includes three phases: a dwell phase, an ignition or spark phase, and a post-ignition or combustion phase. In the embodiment shown, the ECU 130 is adapted to analyze the dwell phase of the ionization output signal 138 to determine an actual dwell duration of each of the ignition coils 126.

The ECU 130 is further adapted generate and transmit a dwell duration command signal 160 to each cylinder. The dwell duration command signal 160 represents at least one of the desired dwell duration, the desired dwell duration limited by a maximum dwell duration, the desired dwell duration replaced by the maximum dwell duration, and the dwell duration reduced by a calibrated value. It is understood that a start-of-dwell location (time or angle) may be delayed such that the desired dwell duration is less than the maximum dwell duration. As a non-limiting example, the maximum dwell duration and the calibrated value may be determined using a lookup table. The lookup table includes at least one of a plurality of maximum dwell durations and calibrated values. Each of the maximum dwell durations corresponds to the maximum allowable spark duration generated from an engine mapping and calibration process for the given operating condition.

In use, the ionization detection circuit 134 of each ignition coil 126 generates an ionization output signal 138 that is received into the ECU 130. Additionally, the sensors 128 generate and transmit respective signals 140 to the ECU 130. The ECU 130 receives and analyzes the signals 140 from the sensors 128 to determine the desired dwell duration based upon the detected dwell current. The ECU 130 compares the desired dwell duration with the maximum dwell duration from the lookup table. Where the desired dwell duration is less than the maximum dwell duration, the desired dwell duration remains unchanged. Contrarily, where the desired dwell duration is greater than the maximum dwell duration, the ECU 130 modifies the desired dwell duration by limiting the desired dwell duration by the maximum dwell duration, replacing the desired dwell duration with the maximum dwell duration, reducing the desired dwell duration by the calibrated value, or delaying the start-of-dwell location. In response, the ECU 130 generates and transmits the dwell duration command signal 160 which represents the modified desired dwell duration to each cylinder 127. The dwell duration command signal 160 controls the primary current of each ignition coil 126 by opening and closing the switch connected to the ignition coil 126, and thereby controls the actual dwell duration thereof.

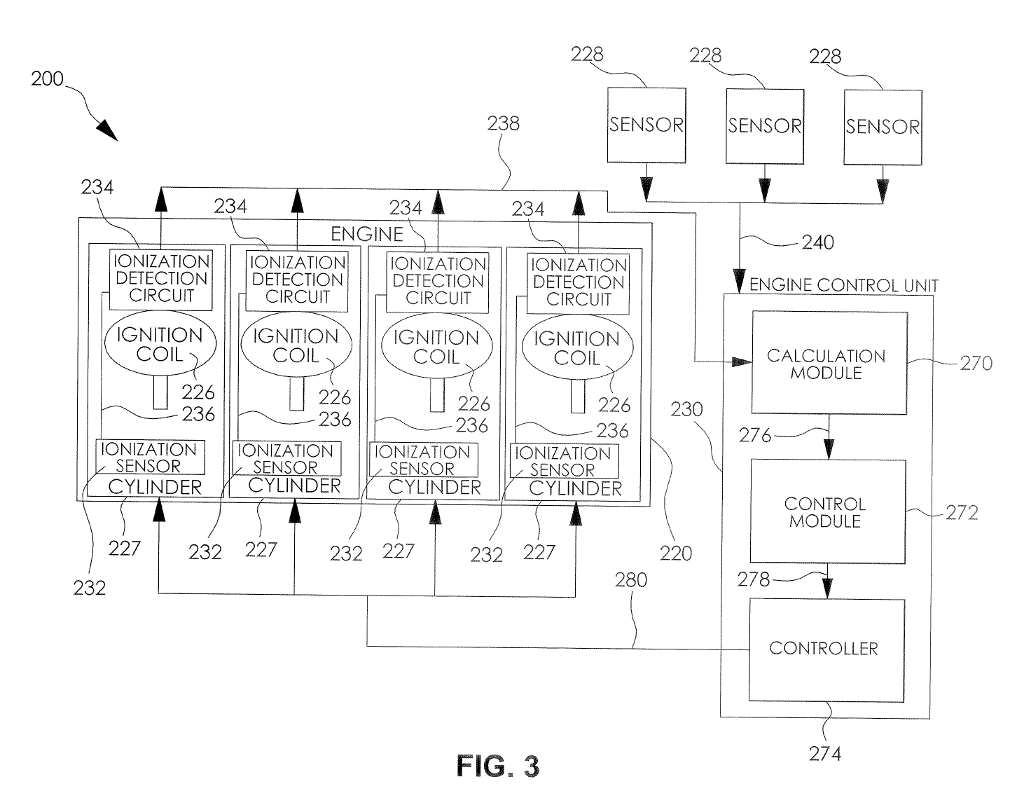

FIG. 3 shows a closed-loop system 200 for controlling an ignition coil dwell according to another embodiment of the present invention. The system 200 as described herein may be used in an internal combustion engine 220 of any number of cylinders such as a four, six, or eight cylinder engine, for example. The system 200 includes at least one ignition coil 226, at least one sensor 228, and an engine control unit (ECU) 230. It is understood that the at least one sensor 228 can be any sensor as desired such as an engine load sensor, an engine temperature sensor, an engine position sensor, a battery voltage sensor, and an air charge temperature sensor, for example. It is further understood that additional or fewer sensors, modules, and components may be included in the system 200, as desired.

Each ignition coil 226 is disposed in a respective cylinder 227 of the engine 220. The ignition coil 226 is connected to a switch and includes a primary winding inductively coupled to a secondary winding. The ECU 230 controls the switch such that the primary winding is in electrical communication with a power supply (battery) when the switch is closed and disconnected from the power supply when the switch is open. The power supply provides an electrical current, commonly referred to as a primary current (Iₚ), to the primary winding. The secondary winding is coupled to a spark plug. In a spark ignition engine, the spark plug extends inside of the engine combustion chamber and may be used as an ionization sensor 232. Use of the spark plug as the ionization sensor 232 eliminates the need to place a separate sensor into the combustion chamber to monitor conditions inside of the combustion chamber. It is understood, however, that other ionization sensors can be used if desired.

The spark plug includes a ground electrode and a spaced apart center electrode, forming a gap therebetween. An ionization detection circuit 234 integrated with each of the ignition coil 226 is adapted to apply a bias voltage across the gap of the spark plug. The bias voltage attracts ions produced during the combustion process of the engine to the gap, creating an ionization current 236. The ionization detection circuit 234 is further adapted to measure and condition the ionization current 236 to generate an ionization output signal 238 and transmit the ionization output signal 238 to the ECU 230. It is understood that the ionization detection circuit 234 can measure and condition the ionization current 236 by at least one of a filtering, amplifying, and a transforming of the ionization current 236, for example. The ionization output signal 238 represents a measure of a local combustion mixture conductivity in the cylinder 227 during the combustion process. The local combustion mixture conductivity is influenced not only by the complex chemical reactions that occur during combustion, but also by the local temperature and turbulence flow during the process.

As illustrated, the at least one sensor 228 is in electrical communication with the ECU 230. The at least one sensor 228 is adapted to generate and transmit a signal 240 to the ECU 230 which represents an operating condition of the engine 220 such as an engine speed, an engine load, and air charge temperature, for example. In the embodiment shown, the ECU 230 is adapted to receive and analyze the signal 240 from the at least one sensor 228 to determine a feed-forward dwell duration. As a non-limiting example, the feed-forward dwell duration may be determined using a lookup table.

The ECU 230 includes a calculation module 270, a control module 272, and a controller 274. It is understood that the ECU 230 may include additional or fewer modules and components, as desired. It is further understood that the modules 270, 272, and the controller 274 may be combined, as desired. The calculation module 270 of the ECU is in electrical communication with the ionization detection circuit 234 and adapted to receive the ionization output signal 238. The ionization output signal 238 typically includes three phases: a dwell phase, an ignition or spark phase, and a post-ignition or combustion phase. In the embodiment shown, the ECU 230 is adapted to analyze the dwell phase and the spark phase of the ionization output signal 238. Typically, a maximum voltage of the dwell phase and a maximum voltage of the combustion phase is less than a maximum voltage of the spark phase. The calculation module 270 includes a comparator. The comparator is adapted to compare the maximum voltages of each of the phases of the ionization output signal 238 to generate a transistor-transistor logic (TTL) signal, where a pulse width of the TTL signal corresponds to the ignition phase of the ionization signal. It is understood that the comparator can be any comparator device, circuit, or system adapted to compare the voltages of the phases of the ionization output signal 238. The calculation module 270 is further adapted to analyze the pulse width of the TTL signal to determine an actual spark duration of each ignition coil 226, and in response, generate and transmit a spark duration feedback signal 276 to the control module 272. The spark duration feedback signal 276 represents the actual spark duration of each ignition coil 226.

The control module 272 is in electrical communication with the calculation module 270. The control module 272 is adapted to receive and analyze the spark duration feedback signal 276. The control module 272 is further adapted to subtract the actual spark duration represented by the spark duration feedback signal 276 from a desired spark duration, and in response generate and transmit an error spark timing signal 278 to the controller 274. As a non-limiting example, the desired spark duration may be determined using a lookup table generated from an engine mapping and calibration process.

The controller 274 is in electrical communication with the control module 272 and adapted to receive the error spark timing signal 278 as an input. The controller 274 can be any stabilizing controller as desired such as a model based controller and a proportional, integral, and derivative (PID) controller, for example. The controller 274 is further adapted to analyze the error spark timing signal 278 to generate a desired dwell duration, and generate and transmit a dwell duration command signal 280 to each cylinder 227. The dwell duration command signal 280 represents a summation of the desired dwell duration and the feed-forward dwell duration, limited by a maximum dwell duration. As a non-limiting example, the maximum dwell duration may be determined using a lookup table. The lookup table includes a plurality of maximum dwell durations. Each of the maximum dwell durations corresponds to a maximum allowable spark duration generated from an engine mapping and calibration process for at least one of a given operating condition such as engine load, air charge temperature, and engine speed, for example.

In use, the sensors 228 generate and transmit respective signals 240 to the ECU 230. The ECU 230 receives and analyzes the signals 240 from the sensors 228 to determine the feed-forward dwell duration. Additionally, the ionization detection circuit 234 of each ignition coil 226 generates an ionization output signal 238 that is received into the calculation module 270 of the ECU 230. In the calculation module 270, the comparator compares the maximum voltages of each of the phases of the ionization output signal 238 to generate a transistor-transistor logic (TTL) signal, where the pulse width of the TTL signal corresponds to the ignition phase of the ionization signal. The calculation module 270 analyzes the pulse width of the TTL signal to determine an actual spark duration of each ignition coil 226. In response, the calculation module 270 generates and transmits a spark duration feedback signal 276 which represents the actual spark duration of each ignition coil 226 to the control module 272.

The control module 272 receives the spark duration feedback signal 276. The control module 272 subtracts the actual spark duration represented by the spark duration feedback signal 276 from the desired spark duration, and in response generates and transmits an error spark timing signal 278 to the controller 274. The controller 274 receives the error spark timing signal 278 as an input and analyzes the error spark timing signal 278 to generate the desired dwell duration. Where the value represented by the error spark timing signal 278 is positive (i.e. the actual spark duration is shorter than the desired spark duration), the desired dwell duration is increased. Conversely, where the value represented by the error spark timing signal 278 is negative (i.e. the actual spark duration is longer than the desired spark duration), the desired dwell duration is decreased. The controller 274 sums the desired dwell duration and the feed-forward dwell duration and limits the result by a maximum dwell duration. In response, the controller 274 generates and transmits a dwell duration command signal 280 to each cylinder 227. The dwell duration command signal 280 controls the primary current of each ignition coil 226 by opening and closing the switch connected to the ignition coil 226, and thereby controls the actual dwell duration thereof.

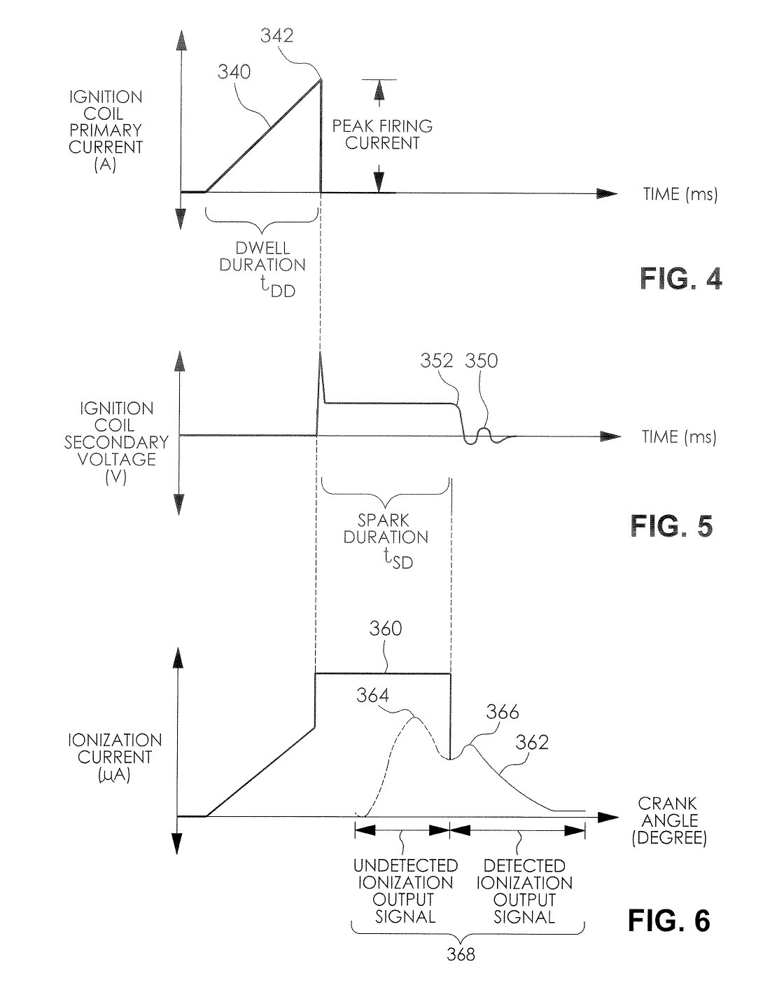

FIGS. 4 to 6 illustrate graphs developed from prior art in-cylinder ionization sensing of an ignition coil over a cycle of an engine at high speeds. An ignition coil primary current versus time trace 340 is graphed in FIG. 4. An ignition coil secondary voltage versus time trace 350 is graphed in FIG. 5. An ionization current versus crank angle trace 360, with a corresponding ionization output signal trace 362 are graphed in FIG. 6.

The ignition coil primary current trace 340 illustrates a dwell duration (t_{DD}) of the ignition coil and a primary current thereof, including a peak firing current 342, over the cycle of the engine. Comparing the ignition coil primary current trace 340 and the ignition coil secondary voltage trace 350, at the peak firing current 342 of the ignition coil, the ignition coil secondary voltage shown in FIG. 5 is maximized, indicating the start of a spark of a spark plug. The ignition coil secondary voltage trace 350 includes an inflection point 352. The inflection point 352 shows a completion of the spark. Accordingly, the duration of the spark (t_{SD}) extends from the moment of peak firing current 342 of the ignition coil until the inflection point 352.

As illustrated in FIG. 5, the ionization output signal trace 362 shows detailed information about the combustion process. A waveform shape of the ionization output signal trace 362 can change with varying loads, speeds, spark timings, air to fuel (A/F) ratios, and exhaust gas re-circulation (EGR) rates, for example. The ionization output signal trace 362 may show when a flame kernel is formed and propagates away from the spark gap, when the combustion is accelerating rapidly and reaches a peak burning rate, and when the combustion ends. A typical ionization output signal trace 362 usually includes two peaks. The first peak 364 represents the flame kernel growth and development, and the second peak 366 represents a re-ionization due to an in-cylinder temperature increase resulting from both pressure increase and flame development in a cylinder.

Comparing the ignition coil secondary voltage trace 350 and the ionization current trace 360, the duration of the spark correlates to a duration of peak ionization current. The ionization output signal trace 362, however, shows that the ionization output signal is produced as a function of a crank angle over a specific crank angle window 368.

As shown, detection of the ionization output signal only occurs after the duration of the spark has concluded. Therefore, where the duration of the spark encroaches upon the crank angle window 368, a portion of the ionization output signal is undetectable, interrupting the ionization output signal.

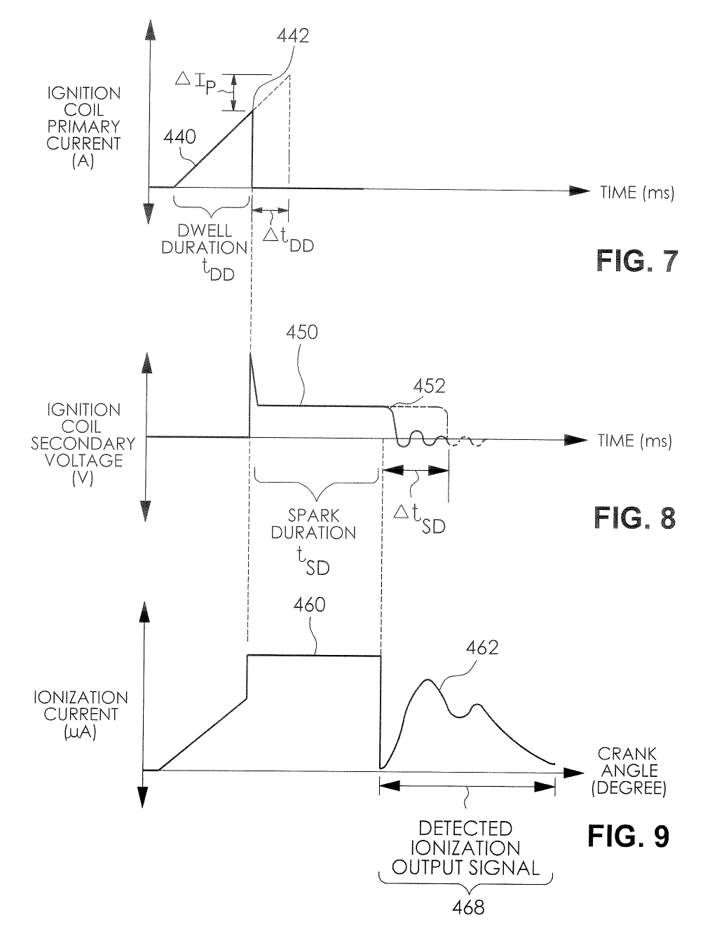

FIGS. 7 to 9 illustrate graphs developed from in-cylinder ionization sensing of the ignition coil 226 of the system 200 over a cycle of the engine at high speeds according to an embodiment of the invention. An ignition coil primary current versus time trace 440 is graphed in FIG. 7. An ignition coil secondary voltage versus time trace 450 is graphed in FIG. 8. An ionization current versus crank angle trace 460, with a corresponding ionization output signal trace 462 are graphed in FIG. 9.

The ignition coil primary current trace 440 illustrates a dwell duration (t_{DD}) of the ignition coil 226 and a primary current thereof, including a peak dwell current 442, over the cycle of the engine. As illustrated, the primary current of the ignition coil has been decreased by the system 200 by Δlₚ, resulting in a decrease of the peak firing current 442 of the ignition coil 226 and a decrease in a dwell duration (t_{DD}) of the ignition coil 226 by Δt_{DD}. Comparing the ignition coil primary current trace 440 and the ignition coil secondary voltage trace 450, at the peak firing current 442 of the ignition coil 226, the ignition coil secondary voltage shown in FIG. 8 is maximized, indicating the start of a spark of the spark plug. The ignition coil secondary voltage trace 450 includes an inflection point 452. The inflection point 452 shows a completion of the spark. Accordingly, the duration of the spark (t_{SD}) has also been decreased and extends from the moment of peak firing current 442 of the ignition coil 226 until the inflection point 452.

Comparing the ignition coil secondary voltage trace 450 as shown in FIG. 8 and the ionization current trace 460 as shown in FIG. 9, the duration of the spark correlates to a duration of peak ionization current. The ionization output signal trace 462, however, shows that the ionization output signal 238 is produced as a function of a crank angle over a specific crank angle window 468.

As illustrated, detection of the ionization output signal 238 only occurs after the duration of the spark has concluded. Therefore, where the system 200 decreases the primary current of the ignition coil 226 and, thereby the dwell duration, the duration of the spark does not encroach upon the crank angle window 468. Accordingly, the ionization output signal 238 in its entirety is detected over the cycle of the engine 220, and an undesirable interruption of the ionization output signal 238 provided to the system 200 is militated against.

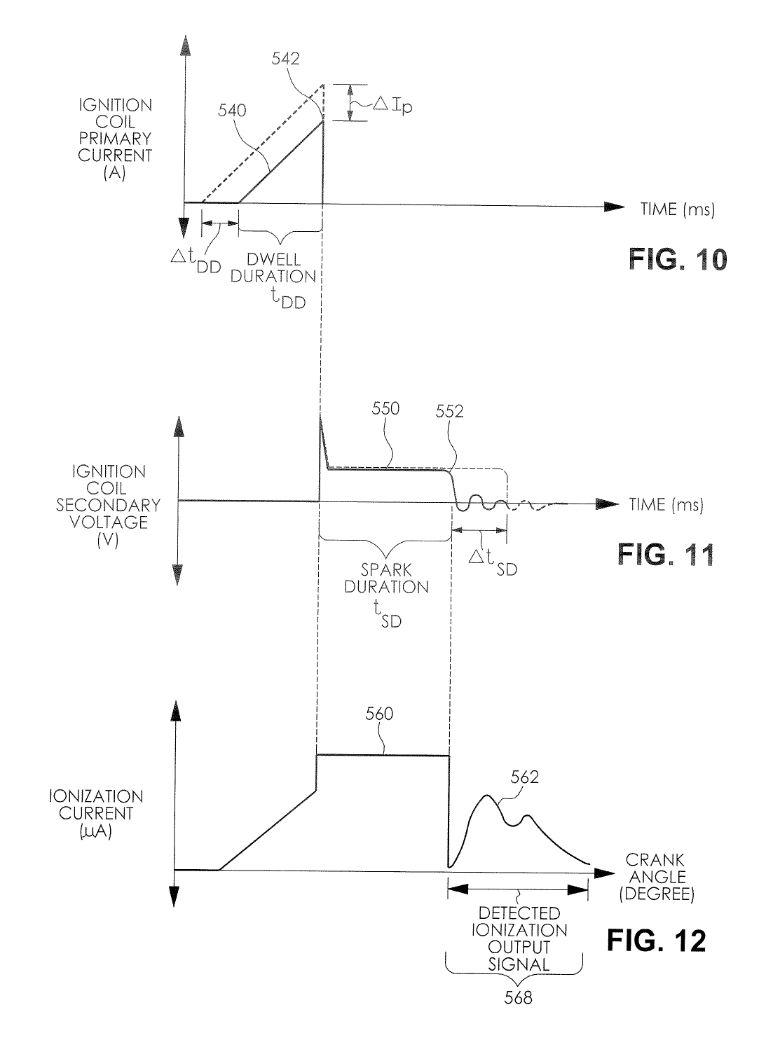

FIGS. 10 to 12 illustrate graphs developed from in-cylinder ionization sensing of the ignition coil 226 of the system 200 over a cycle of the engine at high speeds, where the start of dwell is delayed. An ignition coil primary current versus time trace 540 is graphed in FIG. 10. An ignition coil secondary voltage versus time trace 550 is graphed in FIG. 11. An ionization current versus crank angle trace 560, with a corresponding ionization output signal trace 562 are graphed in FIG. 12.

The ignition coil primary current trace 540 illustrates a dwell duration (t_{DD}) of the ignition coil 226 and a primary current thereof, including a peak firing current 542, over the cycle of the engine. As illustrated, the start of the dwell of the ignition coil has been delayed by the system 200, resulting in a decrease of the primary current of the ignition coil by ΔIₚ and a decrease in a dwell duration (t_{DD}) of the ignition coil 226 by Δt_{DD}. Comparing the ignition coil primary current trace 540 and the ignition coil secondary voltage trace 550, at the peak firing current 542 of the ignition coil 226, the ignition coil secondary voltage shown in FIG. 11 is maximized, indicating the start of a spark of the spark plug. The ignition coil secondary voltage trace 550 includes an inflection point 552. The inflection point 552 shows a completion of the spark. Accordingly, the duration of the spark (t_{SD}) has also been decreased and extends from the moment of peak firing current 542 of the ignition coil 226 until the inflection point 552.

Comparing the ignition coil secondary voltage trace 550 as shown in FIG. 11 and the ionization current trace 560 as shown in FIG. 12, the duration of the spark correlates to a duration of peak ionization current. The ionization output signal trace 562, however, shows that the ionization output signal 238 is produced as a function of a crank angle over a specific crank angle window 568.

As illustrated, detection of the combustion ionization output signal 238 only occurs after the duration of the spark has concluded. Therefore, where the system 200 delays the start of the dwell of the ignition coil 226 and, thereby decreases the dwell duration, the duration of the spark does not encroach upon the crank angle window 568. Accordingly, the ionization output signal 238 in its entirety is detected over the cycle of the engine, and an undesirable interruption of the ionization output signal 238 provided to the system 200 is militated against.

The system 10, 100, 200 eliminates the need for ignition systems which disable in-cylinder ion sensing at high engine speeds or reduce the duration of the spark by utilizing an ignition coil with a significantly higher firing current than the industry standard or adding a secondary resistance to the ignition coil.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An ignition system for controlling an ignition coil charge (dwell) duration comprising:
at least one sensor adapted to generate and transmit a signal which represents an operating condition of the ignition system; and
a control unit in electrical communication with the at least one sensor, the control unit adapted to receive and analyze the signal, and generate a dwell duration command signal in response to the analysis of the signal, wherein the dwell duration command signal controls a primary current of at least one ignition coil to facilitate detection of an ionization output signal.

2. The ignition system according to claim 1, wherein the dwell duration command signal represents a desired dwell duration.

3. The ignition system according to claim 2, wherein the desired dwell duration is determined using a lookup table.

4. The ignition system according to claim 2, wherein the control unit modifies the desired dwell duration when the desired dwell duration is greater than a maximum dwell duration by at least one of limiting the desired dwell duration by the maximum dwell duration, replacing the desired dwell duration with the maximum dwell duration, reducing the desired dwell duration by a calibrated value and delaying a start of dwell.

5. The ignition system according to claim 4, wherein at least one of the maximum dwell duration and the calibrated value is determined using a lookup table.

6. The ignition system according to claim 1, wherein the at least one ignition coil is integrated with an ionization detection circuit, the ionization detection circuit adapted to generate and transmit the ionization output signal to the control unit.

7. An ignition system for controlling an ignition coil charge (dwell) duration comprising:
at least one ignition coil integrated with an ionization detection circuit, the ionization detection circuit adapted to generate and transmit an ionization output signal; and
a control unit in electrical communication with the ionization detection circuit, the control unit including:
a calculation module adapted to receive and analyze the ionization output signal, and generate and transmit a spark duration feedback signal in response to the analysis of the ionization output signal;
a control module in electrical communication with the calculation module, the control module adapted to receive and analyze the spark duration feedback signal, and generate and transmit an error spark timing signal in response to the analysis of the spark duration feedback signal; and
a controller in electrical communication with the control module, the controller adapted to receive and analyze the error spark timing signal, and generate and transmit a dwell duration command signal in response to the analysis of the error spark timing signal, wherein the dwell duration command signal controls a primary current of the at least one ignition coil to facilitate detection of the ionization output signal.

8. The ignition system according to claim 7, further comprising at least one sensor adapted to generate and transmit a signal which represents an operating condition of the ignition system to the control unit.

9. The ignition system according to claim 8, wherein the control unit is adapted to receive and analyze the signal from the at least one sensor to determine a feed-forward dwell duration.

10. The ignition system according to claim 7, wherein the calculation module includes a comparator adapted to compare maximum voltages of a plurality of phases of the ionization output signal to generate a transistor-transistor logic (TTL) signal, the comparator further adapted to analyze a pulse width of the TTL signal to generate the spark duration feedback signal.

11. The ignition system according to claim 7, wherein the spark duration feedback signal represents the actual spark duration of the at least one ignition coil.

12. The ignition system according to claim 11, wherein the error spark timing signal represents a value resulting from a subtraction of the actual spark duration from a desired spark duration.

13. The ignition system according to claim 7, wherein the dwell duration command signal represents a desired dwell duration.

14. The ignition system according to claim 13, wherein the desired dwell duration is increased where the value represented by the error spark timing signal is positive and decreased where the value represented by the error spark timing signal is negative.

15. The ignition system according to claim 13, wherein the desired dwell duration is determined using a stabilizing controller.

16. The ignition system according to claim 13, wherein the dwell duration command signal represents a summation of the desired dwell duration and a feed-forward dwell duration, limited by a maximum dwell duration.

17. The ignition system according to claim 16, wherein the maximum dwell duration is determined using a lookup table.

18. A method for controlling a dwell duration of an ignition coil, the method comprising the steps of:
providing at least one sensor adapted to generate and transmit a signal which represents an operating condition of an ignition system;
providing a control unit in electrical communication with the at least one sensor, the control unit adapted to receive and analyze the signal, and generate a dwell duration command signal in response to the analysis of the signal, wherein the dwell duration command signal represents a desired dwell duration and controls a primary current of at least one ignition coil to facilitate detection of an ionization output signal;
generating the signal from the operating condition of the ignition system;
transmitting the signal to the control unit;
analyzing the signal;
generating the dwell duration command signal in response to the analysis of the signal; and
transmitting the dwell duration command signal to the ignition system.

19. The method according to claim 18, wherein the control unit modifies the desired dwell duration where the desired dwell duration is greater than a maximum dwell duration by at least one of limiting the desired dwell duration by the maximum dwell duration, replacing the desired dwell duration with the maximum dwell duration, reducing the desired dwell duration by a calibrated value, and delaying a start of dwell.

20. The method according to claim 18, further comprising the steps of:
providing at least one ignition coil integrated with an ionization detection circuit, the ionization detection circuit in electrical communication with the control unit and adapted to generate and transmit an ionization output signal;
providing a calculation module adapted to receive and analyze the ionization output signal, and generate and transmit a spark duration feedback signal in response to the analysis of the ionization output signal;
providing a control module in electrical communication with the calculation module, the control module adapted to receive and analyze the spark duration feedback signal, and generate and transmit an error spark timing signal in response to the analysis of the spark duration feedback signal;
providing a controller in electrical communication with the control module, the controller adapted to receive and analyze the error spark timing signal, and generate and transmit a dwell duration command signal in response to the analysis of the signal from the at least one sensor and the error spark timing signal;
generating the ionization output signal;
transmitting the ionization output signal to the calculation module;
analyzing the ionization output signal;
generating the spark duration feedback signal in response to the analysis of the ionization output signal;
transmitting the spark duration feedback signal to the control module;
analyzing the spark duration feedback signal;
generating the error spark timing signal in response to the analysis of the spark duration feedback signal;
transmitting the error spark timing signal to the controller;
analyzing the error spark timing signal; and
generating the dwell duration command signal in response to the analysis of the signal from the at least one sensor and the error spark timing signal.
